(19) United States
(12) Patent Application Publication
(10) Pub. No.: US 2022/0315439 A1
(43) Pub. Date: Oct. 6, 2022

(54) ALUMINA PARTICLE PRODUCTION METHOD

(71) Applicant: DIC Corporation, Tokyo (JP)

(72) Inventors: Jianjun YUAN, Chiba (JP); Hiroshi KINOSHITA, Chiba (JP)

(21) Appl. No.: 17/765,936

(22) PCT Filed: Oct. 1, 2020
(86) PCT No.: PCT/JP2020/037393

§ 371 Date: Apr. 1, 2022

(30) Foreign Application Priority Data
Oct. 9, 2019 (JP) 2019-186057

(51) Int. Cl. C01F 7/30

(52) U.S. Cl. CPC C01F 7/30; C01P 2006/12

(57) ABSTRACT

An alumina particle production method comprising a step of firing an aluminum compound in presence of a molybdenum compound and a potassium compound, the aluminum compound containing aluminum hydroxide.

### TECHNICAL FIELD

The present invention relates to an alumina particle production method.

This application claims priority based on Japanese Patent Application No. 2019-186057 filed in Japan on Oct. 9, 2019, the contents of which are hereby incorporated herein.

### BACKGROUND ART

In recent years, electronic devices represented by personal computers, TVs, cellular phones, and the like have been developing at a dizzying pace and are being developed aiming at higher density, higher power, and lighter weight. As the performance of electronic devices increases, the amount of heat generated per unit area is increasing. When electronic devices are in a high temperature environment for a long period of time, their operation becomes unstable, leading to malfunctions, performance degradation, and failures, and thus there is a growing need to efficiently dissipate the generated heat.

Moreover, heat dissipation measures are also essential for lighting equipment including light-emitting diodes (LEDs) as light sources, for which demand is rapidly increasing due to their longer life, lower power consumption, and a lower environmental load than incandescent lamps and fluorescent lamps. Until now, metallic materials and ceramic materials have been mainly used for components that require high heat dissipation. However, in adapting to the miniaturization of electric and electronic components, metallic materials and ceramic materials have difficulties in terms of lightness in weight and molding processability and are being replaced by resin materials.

Although thermoplastic resins have excellent ease of molding processing, appearance, economy, mechanical strength, and other physical and chemical properties, resin-based materials generally have low thermal conductivity, and thus studies are being conducted to increase thermal conductivity by blending thermally conductive fillers into thermoplastic resins.

Curable resins are materials widely used in electric insulating materials, semiconductor sealing materials, fiber-reinforced composite materials, coating materials, molding materials, adhesive materials, and the like; among these applications, heat dissipation is required especially in adhesives, semiconductor sealing materials, electric insulating materials, printed circuit board materials, and the like. Studies to increase thermal conductivity by blending thermally conductive fillers into curable resins are being conducted.

As one of the thermally conductive fillers in this case, aluminum oxide in the order of micrometers is used. Aluminum oxide has various crystal forms such as α, β, γ, δ, and θ; it is known that the thermal conductivity of aluminum oxide in the α crystal form is the highest. However, aluminum oxide in the α crystal form is generally plate-shaped or irregularly shaped, and thus even though it is attempted to be highly filled in organic polymer compounds in order to obtain high thermal conductivity, there arises a problem of increased viscosity and the like, and it cannot be highly filled.

By the way, in recent years, inorganic material synthesis research learning from nature and living organisms has actively been conducted. In the research, the flux method is a method of precipitating crystals from a solution of inorganic compounds or metals at high temperatures by making the most of the wisdom of how crystals (minerals) are created in nature. Examples of the features of this flux method include the ability to grow crystals at a temperature much lower than the melting point of a target crystal, the growth of crystals with very few defects, and the ability to control particle shape.

The inventors of the present invention have previously made it possible to produce alumina particles useful as highly thermally conductive fillers by using the flux method (PTL 1 and PTL 2).

### CITATION LIST

### Patent Literature

PTL 1: Japanese Unexamined Patent Application Publication No. 2016-166374

PTL 2: WO 2018/112810

### SUMMARY OF INVENTION

### Technical Problem

High-quality alumina particles useful as highly thermally conductive fillers can be obtained by the alumina particle production methods in PTL 1 and PTL 2, which are excellent methods. On the other hand, in the step of producing alumina particles, installation of special equipment is required or the operation of taking alumina particles out of a fluxing agent is complicated in some cases.

Given these circumstances, an object of the present invention is to provide an alumina particle production method by the flux method, with fewer equipment loads and being capable of easily taking alumina particles out of a fluxing agent.

### Solution to Problem

To solve the above problems, the inventors of the present invention have earnestly conducted research to find out that the above problems can be solved by using a compound containing potassium in combination in the flux method and using aluminum hydroxide for an aluminum compound as a raw material and to complete the present invention.

Specifically, the present invention has the following aspects.

(1) An alumina particle production method including a step of firing an aluminum compound in the presence of a molybdenum compound and a potassium compound, the aluminum compound containing aluminum hydroxide.
(2) The production method according to (1), in which an average particle diameter of the alumina particles is 20 μm or less.
(3) The production method according to (1) or (2), in which a molar ratio (molybdenum/aluminum) of molybdenum atoms in the molybdenum compound to aluminum atoms in the aluminum compound is 0.01 to 0.2.
(4) The production method according to any one of (1) to (3), in which a molar ratio (molybdenum/potassium) of molybdenum atoms in the molybdenum compound to potassium atoms in the potassium compound is 0.1 to 5.
(5) The production method according to any one of (1) to (4), in which the alumina particles contain molybdenum.
(6) The production method according to any one of (1) to (5), in which the alumina particles are other than hexagonal bipyramidal and are polyhedral particles, with a crystal face other than the [001] face as a main crystal face, and with an area of a largest flat face being one-eighth or less of a total surface area of the aluminum oxide particles.

### Advantageous Effects of Invention

The present invention provides an alumina particle production method by the flux method, with fewer equipment loads and being capable of easily taking alumina particles out of a fluxing agent.

### BRIEF DESCRIPTION OF THE DRAWING

FIG. 1 is a scanning electron microscope (SEM) image of alumina particles obtained in Example 5.

### DESCRIPTION OF EMBODIMENTS

The following describes aspects for performing the present invention in detail.

<<Alumina Particle Production Method>>

An alumina particle production method according to an embodiment is a method including a step of firing an aluminum compound in the presence of a molybdenum compound and a potassium compound, the aluminum compound containing aluminum hydroxide. The alumina particle production method according to the embodiment includes a cooling step cooling the alumina particles containing molybdenum obtained at the firing step and a posttreatment step removing a fluxing agent as needed.

A compound containing molybdenum and potassium, which is suitable as the fluxing agent, can be produced at a firing step with a molybdenum compound and a potassium compound as raw materials, which are lower in price and easier to obtain, for example. Both a case in which the molybdenum compound and the potassium compound are used as the fluxing agent and a case in which the compound containing molybdenum and potassium is used as the fluxing agent are regarded as the case in which the molybdenum compound and the potassium compound are used as the fluxing agent, that is, in the presence of the molybdenum compound and the potassium compound.

[Firing Step]

The firing step is a step firing the aluminum compound in the presence of the molybdenum compound and the potassium compound. At the firing step, a metal compound may further be used.

The alumina particle production method according to the embodiment can include a step of mixing together the molybdenum compound, the potassium compound, and/or the compound containing molybdenum and potassium to form a mixture (a mixing step) and can include a step of firing the mixture (a firing step) prior to the firing step.

(Molybdenum Compound)

The molybdenum compound is not limited to a particular compound; examples thereof include metal molybdenum and molybdenum compounds such as molybdenum oxide, molybdenum sulfide, lithium molybdate, sodium molybdate, potassium molybdate, calcium molybdate, ammonium molybdate, H₃PMo₁₂O₄₀, and H₃SiMo₁₂O₄₀. In this case, the molybdenum compound contains isomers. The molybdenum oxide, for example, may be molybdenum dioxide (IV) (MoO₂) or molybdenum trioxide (VI) (MoO₃). Potassium molybdate has a structural formula of K₂MoₙO<874>3n+1</874>, in which n may be 1, 2, or 3. Among these, the molybdenum compound is preferably at least one selected from the group consisting of molybdenum trioxide, molybdenum dioxide, ammonium molybdate, and potassium molybdate and is more preferably molybdenum trioxide.

The molybdenum compound described above may be used singly or be used with two or more combined.

Potassium molybdate (K₂MoₙO₃ₙ₊₁, n=1 to 3) also corresponds to the compound containing molybdenum and potassium. Potassium molybdate contains potassium and can thus also have a function as the potassium compound described below.

(Potassium Compound)

The potassium compound is not limited to a particular compound; examples thereof include potassium chloride, potassium chlorite, potassium chlorate, potassium sulfate, potassium hydrogen sulfate, potassium sulfite, potassium hydrogen sulfite, potassium nitrate, potassium carbonate, potassium hydrogen carbonate, potassium acetate, potassium oxide, potassium bromide, potassium bromate, potassium hydroxide, potassium silicate, potassium phosphate, potassium hydrogen phosphate, potassium sulfide, potassium hydrogen sulfide, potassium molybdate, and potassium tungstate. In this case, the potassium compound contains isomers as with the case of the molybdenum compound. Among these, the potassium compound is preferably at least one selected from the group consisting of potassium carbonate, potassium bicarbonate, potassium oxide, potassium hydroxide, potassium chloride, potassium sulfate, and potassium molybdate and is more preferably at least one selected from the group consisting of potassium carbonate, potassium bicarbonate, potassium chloride, potassium sulfate, and potassium molybdate.

The potassium compound described above may be used singly or be used with two or more combined.

As with the above, potassium molybdate also corresponds to the compound containing molybdenum and potassium. Potassium molybdate contains molybdenum and can thus also have a function as the molybdenum compound described above.

The molar ratio (molybdenum/potassium) of the molybdenum element of the molybdenum compound to the potassium element of the potassium compound is preferably 5 or less, is more preferably 0.1 to 5, and is even more preferably 0.15 to 3. When the molar ratio (molybdenum/potassium) is within the above range, the sublimation of MoO₃ at the firing step is hard to occur, and equipment loads for MoO₃ recovery and the like are reduced.

The molar ratio (molybdenum/potassium) can also be represented as the molar ratio (molybdenum/potassium) of molybdenum atoms in the molybdenum compound and/or the compound containing molybdenum and potassium to potassium atoms in the potassium compound and/or the compound containing molybdenum and potassium.

(Aluminum Compound)

The aluminum compound is a raw material of the alumina particles according to the embodiment.

In the alumina particle production method according to the present embodiment, the aluminum compound as the raw material contains aluminum hydroxide.

The content ratio of aluminum hydroxide to the total mass, or 100% by mass, of the aluminum compound as the raw material, which is not limited to a particular content ratio, may be 50 to 100% by mass, 80 to 100% by mass, 95 to 100% by mass, or 100% by mass, for example.

The inventors of the present invention have found out that using aluminum hydroxide as the aluminum compound as the raw material facilitates adjusting the size of the alumina particles to be produced to a relatively small size.

Although the mechanism by which using aluminum hydroxide results in the relatively small size of the alumina particles to be produced is not clear, the following phenomena are considered.

It is considered that when aluminum hydroxide is fired, the aluminum hydroxide dehydrates in that process to become transition alumina, and through the transition alumina, α-alumina particles are formed. It is presumed that the transition alumina produced originating from aluminum hydroxide is less stable and can easily shift to the more stable α-alumina, and it is considered that many α-crystal nuclei are formed in a lower temperature range when the temperature rises during firing. When many α-crystal nuclei are formed, the amount of the raw materials distributed to each crystal is relatively reduced, and it is inferred that the crystal size of the resulting individual alumina particles will be smaller.

In the alumina particle production method according to the present embodiment, the combined use of the compound containing potassium as the fluxing agent makes it hard for the sublimation of MoO₃ to occur at the firing step due to the formation of potassium molybdate as the fluxing agent. In the method, the sublimation of the fluxing agent is hard to occur, and thus it is preferable to perform an operation of taking the alumina particles out of the fluxing agent after firing. A fired product containing the fluxing agent and the alumina particles that has been cooled after firing becomes a state in which the alumina particles in a solid phase are present in a scattered manner in the fluxing agent in a solid phase. The operation of taking the alumina particles out of the fluxing agent refers to an operation of, after taking the fired product out of a firing vessel (a crucible or a sagger, for example), separating the alumina particles and the fluxing agent from each other to remove the fluxing agent from the surroundings of the alumina particles, for example; this operation can be performed by the posttreatment step described below. At the posttreatment step, the fluxing agent is not necessarily required to completely be removed from the alumina particles.

The alumina particles produced in the present embodiment are relatively small in size, and thus the operation of taking the alumina particles out of the fluxing agent can easily be performed. This is because when the size of the alumina particles is smaller, the alumina particles are more scattered throughout the fluxing agent and are distributed in such a manner that they break the continuous phase of the fluxing agent, which makes the fired product containing the fluxing agent and the alumina particles produced by being fired brittle and facilitates the implementation of the posttreatment step. In addition, it is considered that the amount of fluxing agent adhering to the surroundings of the alumina particles tends to be uniform and small, and the alumina particles can easily be taken out of the fluxing agent by washing or the like at the posttreatment step.

Aluminum hydroxide can be represented by Al(OH)₃, which may be gibbsite or bayerite.

The aluminum compound as the raw material may further contain an aluminum compound that does not correspond to aluminum hydroxide in addition to aluminum hydroxide; examples of the aluminum compound include metal aluminum, aluminum sulfide, aluminum nitride, aluminum fluoride, aluminum chloride, aluminum bromide, aluminum iodide, aluminum sulfate, sodium aluminum sulfate, potassium aluminum sulfate, ammonium aluminum sulfate, aluminum nitrate, aluminum aluminate, aluminum silicate, aluminum phosphate, aluminum lactate, aluminum laurate, aluminum stearate, aluminum oxalate, aluminum acetate, basic aluminum acetate, aluminum propoxide, aluminum butoxide, boehmite, pseudo-boehmite, transition alumina (γ-alumina, δ-alumina, θ-alumina, and the like), α-alumina, and mixed alumina having two or more crystalline phases.

The aluminum compound described above may be used singly or be used with two or more combined.

The aluminum compound may be a commercially available product or be prepared by oneself.

The shape of the aluminum compound is not limited to a particular shape; any of a spherical shape, an amorphous shape, structures with an aspect (wire, fiber, ribbon, tube, and the like), sheet, and the like can suitably be used.

The average particle diameter of the aluminum compound, which is also not limited to a particular value, is preferably 5 nm to 10,000 μm.

The aluminum compound may form a complex with an organic compound. Examples of such a complex include organic-inorganic complexes obtained by modifying the aluminum compound using organosilanes, aluminum compound complexes with polymers adsorbed, and complexes coated with organic compounds. When these complexes are used, the content of the organic compound, which is not limited to a particular content, is preferably 60% by mass or less and is more preferably 30% by mass or less.

The molar ratio (molybdenum/aluminum) of the molybdenum element of the molybdenum compound to the aluminum element of the aluminum compound is preferably 0.2 or less, is preferably 0.01 to 0.2, and is more preferably 0.02 to 0.15.

When the molar ratio (molybdenum/aluminum) is the above upper limit value or less, the operation of taking the alumina particles out of the fluxing agent can easily be performed, and when the molar ratio (molybdenum/aluminum) is the above lower limit value or more, the degree of crystal growth becomes favorable.

The molar ratio (molybdenum/aluminum) can also be represented as the molar ratio (molybdenum/aluminum) of molybdenum atoms in the molybdenum compound and/or the compound containing molybdenum and potassium to aluminum atoms in the aluminum compound.

The molar ratio (molybdenum/aluminum) being the above upper limit value or less means that the amount of the fluxing agent with respect to the aluminum raw material is relatively small. It is considered that the amount of the fluxing agent being small reduces the proportion of the continuous phase of the fluxing agent in the fired product containing the fluxing agent and the alumina particles produced by being fired, which makes the fired product brittle, and also facilitates the posttreatment to remove the fluxing agent, which makes the alumina particles easier to be taken out.

(Metal Compound)

The metal compound can have the function of promoting the crystal growth of α-alumina. The metal compound can be used during firing as desired.

The metal compound, which is not limited to a particular compound, preferably contains at least one selected from the group consisting of Group II metal compounds, Group III metal compounds, and Group IV metal compounds.

Examples of the Group II metal compounds include magnesium compounds, calcium compounds, strontium compounds, and barium compounds.

Examples of the Group III metal compounds include scandium compounds, yttrium compounds, lanthanum compounds, and cerium compounds.

Examples of the Group IV metal compounds include titanium compounds and zirconium compounds.

The metal compounds described above mean oxides, hydroxides, carbonates, and chlorides of metal elements.

Examples of the yttrium compounds, for example, include yttrium oxide (Y₂O₃), yttrium hydroxide, and yttrium carbonate. Among these, the metal compounds are preferably oxides of metal elements. Note that these metal compounds contain isomers.

Among these, the metal compounds are preferably metal compounds of third period elements, metal compounds of fourth period elements, metal compounds of fifth period elements, or metal compounds of sixth period elements, are more preferably metal compounds of fourth period elements or metal compounds of fifth period elements, and are even more preferably metal compounds of fifth period elements. Specifically, it is preferable to use magnesium compounds, calcium compounds, yttrium compounds, lanthanum compounds, and zirconium compounds, it is more preferable to use magnesium compounds, calcium compounds, yttrium compounds, and zirconium compounds, it is even more preferable to use yttrium compounds and zirconium compound, and it is particularly preferable to use zirconium compounds.

The addition rate of the metal compound is preferably 0.02 to 20% by weight, is more preferably 0.6 to 20% by weight, and is even more preferably 5 to 15% by weight with respect to the mass equivalent of aluminum atoms in the aluminum compound. An addition rate of the metal compound of 0.02% by weight or more is preferred because the crystal growth of α-alumina containing molybdenum can appropriately proceed. On the other hand, an addition rate of the metal compound of 20% by weight or less is preferred because α-alumina with a low content of impurities originating from the metal compound can be obtained.

(Firing)

By firing the aluminum compound in the presence of the molybdenum compound and the potassium compound, the alumina particles containing molybdenum can be obtained. This production method is based on the flux method.

The flux method is classified as the solution method. The flux method, more precisely, is a method of crystal growth taking advantage of the fact that a crystal-flux two-component state diagram shows a eutectic type one. The mechanism of the flux method is presumed to be as follows. That is to say, when a mixture of a solute and a flux is heated, the solute and the flux become a liquid phase. In this process, the flux is a melting agent, or in other words, a solute-flux two-component state diagram shows a eutectic type one, and thus the solute melts at a temperature lower than its melting point to form a liquid phase. When the flux is evaporated in this state, the concentration of the flux decreases, or in other words, the effect of lowering the melting point of the solute by the flux reduces, and the evaporation of the flux acting as driving force causes the crystal growth of the solute (the flux evaporation method). The solute and the flux can cause the crystal growth of the solute also by cooling the liquid phase (the slow cooling method).

The flux method has advantages such as the ability to grow crystals at temperatures much lower than the melting point, the ability to precisely control a crystal structure, and the ability to form polyhedral crystal bodies having their own shape.

In the production of alumina particles by the flux method using the molybdenum compound as the flux, although the mechanism is not necessarily clear, it is presumed to be due to the following mechanism, for example. That is to say, when the aluminum compound is fired in the presence of the molybdenum compound, aluminum molybdate is first formed. In this process, the aluminum molybdate grows α-alumina crystals at a lower temperature than the melting point of alumina as can be understood from the above explanation. Then, the crystal growth is accelerated through the decomposition of aluminum molybdate and the evaporation of the flux to obtain the alumina particles, for example. That is to say, the molybdenum compound functions as a flux, and the alumina particles are produced via an intermediate, or aluminum molybdate.

In the alumina particle production method according to the embodiment, the potassium compound is used in combination in the flux method. More specifically, when the molybdenum compound and the potassium compound are used in combination, the molybdenum compound and the potassium compound first react to form potassium molybdate. At the same time, the molybdenum compound reacts with the aluminum compound to form aluminum molybdate. Then, by causing aluminum molybdate to decompose and grow crystals in the presence of potassium molybdate in a liquid phase, for example, the alumina particles can be obtained with fewer equipment loads while inhibiting the evaporation of the flux (the sublimation of MoO₃) described above.

The composition of the potassium molybdate described above, which is not limited to a particular composition, usually contains molybdenum atoms, potassium atoms, and oxygen atoms. The structural formula is preferably represented by K₂MoₙO₃ₙ₊₁. In this case, n is not limited to a particular value; a value in the range of 1 to 3 is preferred because promotion of the growth of the alumina particles effectively functions. The potassium molybdate may contain other atoms; examples of the other atoms include sodium, magnesium, silicon, and iron.

The firing temperature, which is not limited to a particular temperature, is preferably 700° C. or more and is more preferably 900° C. or more. As the upper limit value of the firing temperature, 2,000° C. can be exemplified. The firing temperature is preferably 700 to 2,000° C., is more preferably 900 to 1,600° C., and is even more preferably 900 to 1,200° C., for example. A firing temperature of 700° C. or more is preferred because a flux reaction suitably proceeds.

The state of the molybdenum compound, the potassium compound, the compound containing molybdenum and potassium, the aluminum compound, and the like during firing is not limited to a particular state; they are only required to be mixed together. Examples of the method of mixing include simple mixing that mixes powders together, mechanical mixing using a grinder, a mixer, or the like, and mixing using a mortar or the like. In this process, the resulting mixture may be in either a dry state or a wet state; it is preferably in a dry state from the viewpoint of cost.

The time of firing, which is also not limited to a particular time, is preferably 0.1 to 1,000 hours and is more preferably 1 to 100 hours from the viewpoint of efficiently performing formation of the alumina particles. A firing time of 0.1 hour or more is preferred because the crystal growth of the alumina particles is favorable. On the other hand, a firing time of within 1,000 hours is preferred because production costs can reduce.

The temperature rising rate to the firing temperature, which is not limited to a particular rate, is preferably 1 to 1,000° C./hour, is more preferably 5 to 500° C./hour, and is even more preferably 50 to 300° C./hour. A temperature rising rate of the above lower limit value or more is preferred because the production time can be shortened. On the other hand, a temperature rising rate of the above upper limit value or less is preferred because it is considered that many α-crystal nuclei originating from aluminum hydroxide are easily formed during the temperature rising, and the crystal size of the alumina particles to be produced can moderately be reduced, and the alumina particles can easily be taken out of the fluxing agent.

The atmosphere of firing, which is also not limited to a particular atmosphere, is preferably an oxygen-containing atmosphere such as air or oxygen or an inert atmosphere such as nitrogen or argon, is more preferably an oxygen-containing atmosphere or a nitrogen atmosphere, which has no corrosion, from the viewpoint of the durability of a furnace or the like, and is even more preferably an air atmosphere from the viewpoint of cost, for example.

The pressure during firing, which is also not limited to particular pressure, may be under normal pressure, be under pressurized pressure, or be under reduced pressure. As to the heating means, which is not limited to particular means, a firing furnace is preferably used. Examples of the firing furnace that can be used in this process include tunnel furnaces, roller hearth furnaces, rotary kilns, and muffle furnaces.

[Cooling Step]

The production method according to the present invention may include a cooling step. The cooling step is a step to cool the crystal-grown α-alumina at the firing step.

The cooling rate, which is not limited to a particular rate, is preferably 1 to 1,000° C./hour, is more preferably 5 to 500° C./hour, and is even more preferably 50 to 300° C./hour. A cooling rate of the above lower limit value or more is preferred because the production time can be shortened. On the other hand, a cooling rate of the above upper limit value or less is preferred because the size of the alumina particles to be produced is suitable.

The method of cooling, which is not limited to a particular method, may be natural cooling or use a cooling device.

### [Posttreatment Step]

The production method according to the present invention may include the postprocessing step. The posttreatment step may be a step of separating the alumina particles and the fluxing agent contained in the fired product from each other and can be performed after the fired product is taken out of the firing vessel. The posttreatment step may be performed after the firing step described above, be performed after the cooling step described above, or be performed after the firing step and the cooling step. The posttreatment step may be performed repeatedly two or more times as needed.

Examples of the method removing the flux include washing and high temperature treatment. These can be performed in combination.

The method of cleaning is not limited to a particular method; examples thereof when the flux is water-soluble include washing with water.

Examples of the method of high temperature treatment include a method raising the temperature up to the sublimation point or the boiling point of the flux or more.

With the alumina particle production method according to the present embodiment, the size of the alumina particles to be produced is small, and thus the alumina particles are scattered throughout the fluxing agent and are distributed in such a manner that they break the continuous phase of the flux, which makes the fired product containing the flux and the alumina particles produced by being fired brittle and facilitates the implementation of the posttreatment step. In addition, the distribution of the flux is dispersed, and its amount adhering to the surroundings of the alumina particles tends to be uniform and small, thus facilitating the posttreatment to separate the flux and the alumina particles from each other.

The alumina particle production method according to the present embodiment can produce alumina particles with fewer equipment loads and facilitates separation from the fluxing agent and is thus an excellent method, which can easily produce alumina particles with high utility value.

<<Alumina Particles>>

The alumina particles produced by the alumina particle production method according to the embodiment are not limited to particular alumina particles; as an example, alumina particles having the following characteristics can be produced.

The average particle diameter of the alumina particles obtained by the alumina particle production method according to the present embodiment may be 20 μm or less, be 0.2 to 20 μm, or be 0.5 to 15 μm, for example, from the viewpoint of being capable of being easily taken out of the flux.

The “particle diameter” is the maximum length of the distance between two points on the contour line of the alumina particles. The “average particle diameter of the alumina particles” is an arithmetic mean of the particle diameter measured for at least 50 randomly selected alumina particles from an image obtained with a scanning electron microscope (SEM). The alumina particles to be measured are ones the entire image of the contour line of which is identifiable.

The shape, size, and the like of the alumina particles obtained by the alumina particle production method according to the embodiment can be controlled by selecting the type and the use ratio of the aluminum compound, the molybdenum compound, the potassium compound, and the compound containing molybdenum and potassium, the firing temperature, and the firing time.

The alumina particles obtained by the alumina particle production method according to the embodiment, which may be various crystal forms such as β, γ, δ, and θ, are preferably basically the a crystal form in view of better thermal conductivity. The crystal structure of a general a type aluminum oxide is a hexagonal close-packed lattice, and the most thermodynamically stable crystal structure is a plate shape with the [001] face developed. However, with the alumina particle production method according to the embodiment, by firing the aluminum compound in the presence of the molybdenum compound, the molybdenum compound acts as the fluxing agent, and the alumina particles containing molybdenum with a high α crystallization rate, especially an α crystallization rate of 90% or more with a crystal face other than the [001] face as a main crystal face can be formed more easily. With a crystal face other than the [001] face as a main crystal face means that the area of the [001] face is 20% or less with respect to the total area of the alumina particles.

The shape of the alumina particles obtained by the alumina particle production method according to the embodiment is not limited to a particular shape. Being polyhedral particles, even though not being spherical, is advantageous in that they are easily charged into a resin composition; by using the compound containing molybdenum as the fluxing agent in the alumina particle production method according to the embodiment, for example, polyhedral particles that are basically close to spheres can be obtained, and these polyhedral particles close to spheres are an advantageous form easy to be charged when charged into the resin composition. Among them, the polyhedral particles in which the area of the largest flat face is one-eighth or less of the area of a structure and in particular the area of the largest flat face is one-sixteenth or less of the area of the structure can suitably be obtained.

In addition, it is considered that being the polyhedral particles makes surface contact with high thermal conductivity when the particles come into contact with each other in the resin composition, and it is considered that higher thermal conductivity can be obtained than that of spherical particles even with the same charging rate.

In addition, alumina particles obtained by a general method have a hexagonal bipyramidal shape, which has acute angles, thus causing problems such as damage to equipment when the resin composition is produced or the like. On the other hand, the alumina particles obtained by the alumina particle production method according to the embodiment are basically not the hexagonal bipyramidal shape and are thus hard to cause problems such as damage to equipment. The alumina particles obtained by the alumina particle production method according to the embodiment are basically a polyhedron, which is an octahedron or more, and have a shape close to a spherical shape and are thus hard to cause problems such as damage to equipment. Examples of the polyhedral alumina particles according to the embodiment include 8 to 20-face polyhedrons.

The α crystallization rate of the alumina particles is preferably 90% or more and is more preferably 95 to 100%. An α crystallization rate of 90% or more is preferred because it is advantageous for higher thermal conductivity of the alumina particles.

(Molybdenum)

The alumina particles obtained by the alumina particle production method according to the embodiment can contain molybdenum.

The form in which molybdenum is contained is not limited to a particular form; examples thereof include a form in which molybdenum is placed on the surface of the alumina particles in the form of attaching, covering, bonding, or other forms similar to these, a form in which molybdenum is incorporated into the alumina particles (a form in which molybdenum exists within the alumina particles), and a combination of these forms. In this case, examples of the “form in which molybdenum is incorporated into the alumina particles” include a form in which at least part of atoms forming the alumina particles are replaced by molybdenum and a form in which molybdenum is placed in spaces that can exist inside the crystals of the alumina particles (including spaces created by defects in the crystal structure). In the form of replacing described above, the atoms forming the alumina particles to be replaced, which are not limited to particular atoms, may be any of aluminum atoms, oxygen atoms, and other atoms.

The alumina particles are usually colored because they contain molybdenum. The colored color, which varies depending on the amount of molybdenum contained, is usually a light blue to a dark blue near black; the color tends to become darker in proportion to an increase in molybdenum content. Depending on the composition of the alumina particles according to the present form containing molybdenum, they may be colored in other colors.

Molybdenum can be contained caused by the production method described above.

The molybdenum can be contained in the form of being placed on the surface of the alumina particles through the form of attaching, covering, bonding, or other forms similar to these, a form in which molybdenum is incorporated into an alumina structure (a form in which molybdenum exists within the alumina particles), or a combination of these forms.

The molybdenum contained in the alumina particles may be molybdenum atoms or be molybdenum compounds as exemplified above.

The content of molybdenum, which is not limited to a particular content, is preferably 0.001 to 10% by mass, is more preferably 0.01 to 5% by mass in terms of molybdenum trioxide with respect to 100% by mass of the alumina particles from the viewpoint of the high thermal conductivity of the alumina particles, is even more preferably 0.05 to 2% by mass, and is particularly preferably 0.1 to 1% by mass from the viewpoint of the alumina particles showing high closeness. A content of molybdenum of 0.001% by mass or more is preferred because the crystal growth of the alumina particles can proceed more efficiently, and the crystal quality can improve. On the other hand, a content of molybdenum of 10% by mass or less is preferred because the alumina particles with fewer crystal defects and variations can be obtained, and the thermal conductivity of the particles can improve. In the present specification, for the value of “molybdenum content,” a value measured by XRF analysis described in the examples is adopted.

(Inevitable Impurities)

The alumina particles can contain inevitable impurities.

The inevitable impurities mean impurities that originate from the potassium compound and the metal compound used in the production, are present in the raw materials, or are inevitably mixed into the alumina particles at a production step, which are essentially unnecessary, are present in minute amounts, and do not affect the properties of the alumina particles.

The inevitable impurities are not limited to particular impurities; examples thereof include potassium, magnesium, calcium, strontium, barium, scandium, yttrium, lanthanum, titanium, zirconium, cerium, silicon, iron, and sodium. These inevitable impurities may be contained singly or two or more may be contained.

The content of the inevitable impurities in the alumina particles is preferably 10,000 ppm by mass or less, is more preferably 1,000 ppm by mass or less, and is even more preferably 10 to 500 ppm by mass with respect to the total mass of the alumina particles.

(Other Atoms)

Other atoms mean atoms intentionally added to the alumina particles for the purpose of imparting functions such as coloration and luminescence to the extent that they do not hinder the advantageous effects of the present invention.

The other atoms are not limited to particular atoms; examples thereof include zinc, cobalt, nickel, iron, manganese, titanium, zirconium, calcium, strontium, and yttrium. These other atoms may be used singly or be used with two or more combined.

The content of the other atoms in the alumina particles is preferably 10% by mass or less, is more preferably 5′ by mass or less, and is even more preferably 2% by mass or less with respect to the total mass of the alumina particles.

<Resin Composition Production Method>

According to one embodiment of the present invention, there is provided a resin composition production method.

The production method includes a step of mixing together the alumina particles produced by the alumina particle production method according to the embodiment described above and a resin.

[Alumina Particles]

Examples of the alumina particles include those exemplified in <<Alumina Particles>>, and a description thereof is omitted here.

As to the alumina particles, surface-treated ones can be used.

Only one type of the alumina particles may be used or two or more types combined may be used.

In addition, the alumina particles may be used in combination with other fillers (alumina, spinel, boron nitride, aluminum nitride, magnesium oxide, and magnesium carbonate).

The content of the alumina particles is preferably 5 to 95% by mass and is more preferably 10 to 90% by mass with respect to the total mass of the resin composition. A content of the alumina particles of 5% by mass or more is preferred because the high thermal conductivity of the alumina particles can efficiently be demonstrated. On the other hand, a content of the alumina particles of 95% by mass or less is preferred because the resin composition with excellent moldability can be obtained.

[Resin]

The resin is not limited to a particular resin; examples thereof include thermoplastic resins and thermosetting resins.

The thermoplastic resins are not limited to particular resins; any known and conventional resins used for molding materials or the like can be used. Specific examples thereof include polyethylene resins, polypropylene resins, polymethyl methacrylate resins, polyvinyl acetate resins, ethylene-propylene copolymers, ethylene-vinyl acetate copolymers, polyvinyl chloride resins, polystyrene resins, polyacrylonitrile resins, polyamide resins, polycarbonate resins, polyacetal resins, polyethylene terephthalate resins, polyphenylene oxide resins, polyphenylene sulfide resins, polysulfone resins, polyethersulfone resins, polyetheretherketone resins, polyarylsulfone resins, thermoplastic polyimide resins, thermoplastic urethane resins, polyamino bismaleimide resins, polyamideimide resins, polyetherimide resins, bismaleimide-triazine resins, polymethylpentene resins, fluorinated resins, liquid crystal polymers, olefin-vinyl alcohol copolymers, ionomer resins, polyarylate resins, acrylonitrile-ethylene-styrene copolymers, acrylonitrile-butadiene-styrene copolymers, and acrylonitrile-styrene copolymers.

The thermosetting resins are resins having properties that can change to be substantially insoluble and infusible when cured by heating or means of radiation, catalysts, or the like, and in general, any known and conventional resins used for molding materials or the like can be used. Specific examples thereof include novolac type phenolic resins such as phenol novolac resins and cresol novolac resins; phenolic resins such as unmodified resol phenolic resins and resol type phenolic resins such as oil-modified resol phenolic resins modified with paulownia oil, linseed oil, walnut oil, or the like; bisphenol type epoxy resins such as bisphenol A epoxy resins and bisphenol F epoxy resins; novolac type epoxy resins such as fatty chain-modified bisphenol type epoxy resins, novolac epoxy resins, and cresol novolac epoxy resins; epoxy resins such as biphenyl type epoxy resins and polyalkylene glycol type epoxy resins; urea resins; resins having triazine rings such as melamine resins; vinyl resins such as (meth)acrylic resins and vinyl ester resins; unsaturated polyester resins, bismaleimide resins, polyurethane resins, diallyl phthalate resins, silicone resins, resins having benzoxazine rings, and cyanate ester resins.

The resin described above may be used singly or be used with two or more combined. In this case, two or more thermoplastic resins may be used, two or more thermosetting resins may be used, or one or more thermoplastic resins and one or more thermosetting resins may be used.

The content of the resin is preferably 5 to 90% by mass and is more preferably 10 to 70% by mass with respect to the total mass of the resin composition. A content of the resin of 5% by mass or more is preferred because excellent moldability can be imparted to the resin composition. On the other hand, a content of the resin of 90% by mass or less is preferred because high thermal conductivity can be obtained as a compound after being molded.

[Curing Agent]

The resin composition may be mixed with a curing agent as needed.

The curing agent is not limited to a particular curing agent, and any known ones can be used.

Specific examples thereof include amine-based compounds, amide-based compounds, acid anhydride-based compounds, and phenolic compounds.

Examples of the amine-based compounds include diaminodiphenylmethane, diethylenetriamine, triethylenetetramine, diaminodiphenyl sulfone, isophoronediamine, imidazole, BF₃-amine complexes, and guanidine derivatives.

Examples of the amide-based compounds include dicyandiamide and polyamide resins synthesized from a dimer of linolenic acid and ethylenediamine.

Examples of the acid anhydride-based compounds include phthalic anhydride, trimellitic anhydride, pyromellitic anhydride, maleic anhydride, tetrahydrophthalic anhydride, methyltetrahydrophthalic anhydride, methylnadic anhydride, hexahydrophthalic anhydride, and methylhexahydrophthalic anhydride.

Examples of the phenolic compounds include phenol novolac resins, cresol novolac resins, aromatic hydrocarbon formaldehyde resin-modified phenolic resins, dicyclopentadiene phenol-additive resins, phenol aralkyl resins (Zylock resin), polyvalent phenol novolac resins synthesized from a polyvalent hydroxy compound represented by resorcinol novolac resins and formaldehyde, naphthol aralkyl resins, trimethylolmethane resins, tetraphenylolethane resins, naphthol novolac resins, naphthol-phenol co-condensed novolac resins, naphthol-cresol co-condensed novolac resins, biphenyl-modified phenolic resins (polyvalent phenolic compounds with phenolic nuclei linked by bismethylene groups), biphenyl-modified naphthol resins (polyvalent naphthol compounds with phenolic nuclei linked by bismethylene groups), aminotriazine-modified phenolic resins (polyvalent phenolic compounds with phenolic nuclei linked by melamine, benzoguanamine, or the like), and polyvalent phenol compounds such as alkoxy group-containing aromatic ring-modified novolac resins (polyvalent phenol compounds in which the phenolic nucleus and the alkoxy group-containing aromatic ring are linked by formaldehyde).

The curing agent described above may be used singly or be used with two or more combined.

[Curing Accelerator]

The resin composition may be mixed with a curing accelerator as needed.

The curing accelerator has the function of accelerating curing when the composition is cured.

The curing accelerator is not limited to a particular compound; examples thereof include phosphorus-based compounds, tertiary amines, imidazole, organic acid metal salts, Lewis acids, and amine complex salts.

The curing accelerator described above may be used singly or be used with two or more combined.

[Curing Catalyst]

The resin composition may be mixed with a curing catalyst as needed.

The curing catalyst has the function of causing the curing reaction of a compound having epoxy groups to proceed in place of the curing agent.

The curing catalyst is not limited to a particular curing catalyst, and known and conventional thermal polymerization initiators and active energy ray polymerization initiators can be used.

The curing catalyst may be used singly or be used with two or more combined.

[Viscosity Modifier]

The resin composition may be mixed with a viscosity modifier as needed.

The viscosity modifier has the function of modifying the viscosity of the composition.

The viscosity modifier is not limited to a particular viscosity modifier, and organic polymers, polymer particles, inorganic particles, or the like can be used.

The viscosity modifier may be used singly or be used with two or more combined.

[Plasticizer]

The resin composition may be mixed with a plasticizer as needed.

The plasticizer has the function of improving the processability, flexibility, and weatherability of thermoplastic synthetic resins.

The plasticizer is not limited to a particular plasticizer, and phthalate esters, adipate esters, phosphate esters, trimellitate esters, polyesters, polyolefins, and polysiloxanes can be used.

The plasticizer described above may be used singly or be used with two or more combined.

[Mixing]

The resin composition according to the present form is obtained by mixing together the alumina particles and the resin and, in addition, other compounding materials as needed. The method of mixing is not limited to a particular method, and they are mixed together by any known and conventional methods.

When the resin is a thermosetting resin, examples of a general method for mixing together the thermosetting resin, the alumina particles, and the like include a method sufficiently mixing together certain amounts of the thermosetting resin, the alumina particles, and other components as needed with a mixer or the like and then kneading the mixture with three rolls or the like to obtain a liquid composition with fluidity. Examples of the method for mixing together the thermosetting resin, the alumina particles, and the like in another embodiment include a method sufficiently mixing together certain amounts of the thermosetting resin, the alumina particles, and other components as needed with a mixer or the like, then melt kneading the mixture with a mixing roll, an extruder, or the like, and then cooling it to obtain a solid composition. With regard to a mixed state, when compounding materials such as a curing agent and a catalyst are blended, it is only required that the thermosetting resin and the compounding materials be sufficiently uniformly mixed together; it is more preferred if the alumina particles are also uniformly dispersed and mixed.

When the resin is a thermoplastic resin, examples of a general method for mixing together the thermoplastic resin, the alumina particles, and the like include a method mixing together the thermoplastic resin, the alumina particles, and other components as needed in advance using various kinds of mixers such as a tumbler and Henschel mixer and then melt kneading the mixture with a mixer such as a Banbury mixer, a roll, a Brabender, a uniaxial kneading extruder, a biaxial kneading extruder, a kneader, or a mixing roll. The temperature of the melt kneading, which is not limited to a particular temperature, may usually be in the range of 240 to 320° C.

A coupling agent may externally be added to the resin composition, as it can further enhance the fluidity of the resin composition and the filler filling properties of the alumina particles and the like. By externally adding the coupling agent, the adhesion between the resin and the alumina particles can further be enhanced, the interfacial thermal resistance between the resin and the alumina particles reduces, and the thermal conductivity of the resin composition can improve.

As to the coupling agent, which is not limited to particular one, a silane-based coupling agent is preferably used. The silane-based coupling agent is not limited to a particular silane-based coupling agent; examples thereof include vinyltrichlorosilane, vinyltriethoxysilane, vinyltrimethoxysilane, γ-methacryloxypropyltrimethoxysilane, β(3,4-epoxycyclohexyl)ethyltrimethoxysilane, γ-glycidoxypropyltrimethoxysilane, γ-glycidoxypropylmethyldiethoxysilane, N-β(aminoethyl)γ-aminopropyltrimethoxysilane, N-β(aminoethyl)γ-aminopropylmethyldimethoxysilane, γ-aminopropyltriethoxysilane, N-phenyl-γ-aminopropyltrimethoxysilane, γ-mercaptopropyltrimethoxysilane, and γ-chloropropyltrimethoxysilane.

The coupling agent described above may be used singly or be used with two or more combined.

The addition amount of the coupling agent, which is not limited to a particular amount, is preferably 0.01 to 5% by mass and is more preferably 0.1 to 3% by mass with respect to the total mass of the resin.

[Resin Composition]

According to one embodiment, the resin composition can be used as a thermally conductive material. The thermally conductive material can contain the resin composition according to the embodiment.

The alumina particles contained in the resin composition provides excellence in the thermal conductivity of the resin composition, and thus the resin composition is used preferably as a heat-dissipating member and more preferably as an insulating heat-dissipating member. This can improve the heat dissipation function of devices and contribute to making devices smaller, lighter, and more powerful.

<Cured Product Production Method>

According to one embodiment of the present invention, there is provided a cured product production method. The production method includes curing the resin composition produced as described above.

The curing temperature, which is not limited to a particular temperature, is preferably 20 to 300° C. and is more preferably 50 and 200° C.

The curing time, which is not limited to a particular time, is preferably 0.1 to 10 hours and is more preferably 0.2 to 3 hours.

The shape of the cured product varies depending on desired applications and can be designed as appropriate by those skilled in the art.

### EXAMPLES

The following describes the present invention specifically with reference to the examples; the present invention is not limited to these examples.

### Example 1

Aluminum hydroxide (manufactured by Showa Denko K.K., average particle diameter: 1.0 μm) in an amount of 40 g, potassium carbonate (manufactured by Kanto Chemical Co., Inc.) in an amount of 10 g, and molybdenum trioxide (manufactured by Taiyo Koko Co., Ltd.) in an amount of 10 g were mixed together in a mortar to obtain a mixture. The resulting mixture was put into a crucible, the temperature of which was raised up to 1,100° C. under a condition of 3° C./min, and was fired with a ceramic electric furnace at 1,100° C. for 5 hours. Subsequently, after lowering the temperature to room temperature under a condition of 3° C./min, the fired product was taken out of the crucible, and the weight of the fired product was measured to confirm that there was no evaporation of molybdenum trioxide. The fired product was washed with water to wash off the fluxing agent and was then dried to obtain light blue powder. SEM observation confirmed the formation of polyhedral α-alumina. From a result of X-ray fluorescence quantitative analysis, it was confirmed that the obtained particles contained molybdenum in an amount of 0.50% by mass in terms of trioxide equivalent.

Table 1 lists the formulations (g) of the respective raw materials.

Table 1 lists the molar ratio [Mo]/[K] of molybdenum atoms in the molybdenum compound to potassium atoms in the potassium compound and the molar ratio [Mo]/[Al] of molybdenum atoms in the molybdenum compound to aluminum atoms in the aluminum compound of the raw materials.

### Examples 2 to 6

Alumina particles were produced in the same way as in Example 1 except that the amounts of the molybdenum compound and the potassium compound were changed as listed in Table 1.

### Comparative Example 1

Alumina particles were produced in the same way as in Example 1 except that the potassium compound was not blended.

### Comparative Example 2

Alumina particles were produced in the same way as in Example 1 except that 26 g of transition alumina (manufactured by Chalco, average particle diameter: 45 μm) was used in place of aluminum hydroxide and the amounts of the molybdenum compound and the potassium compound were changed as listed in Table 1.

(Evaluation)

The following evaluations were performed on the production process of the alumina particles and the produced alumina particles.

### <Determination of Molybdenum Trioxide Sublimation>

The contents (the fired product) were taken out of the crucible after firing and were weighed, and the amount of molybdenum trioxide evaporated was determined from a difference from the weight of the charged raw materials. Table 1 lists the evaluation results.

<Evaluation of Ease of Taking out of Alumina Particles>

The contents (the fired product) were taken out of the crucible after firing, the fired product taken out was washed with water to wash off the fluxing agent, and an operation of taking the alumina particles out of the fluxing agent was performed to evaluate easiness of taking out of the alumina particles according to the following criteria. Table 1 lists the evaluation results.

“A” . . . The fired product can be taken out of the crucible by lightly pushing in a spatula. By washing the fired product, without being crushed in a mortar, with water in an amount not more than five times the amount of alumina (on a weight basis), the fluxing agent can be washed off, and the alumina particles can be taken out.
“B” . . . The fired product can be taken out of the crucible by lightly pushing in a spatula. By washing the fired product, after being crushed in a mortar, with water in an amount not more than five times the amount of alumina (on a weight basis), the fluxing agent can be washed off, and the alumina particles can be taken out.
“C” . . . The fired product cannot be taken out of the crucible by lightly pushing in a spatula and can be taken out using a chisel and a hammer. Unless the fired product is crushed in a mortar and is washed with water in an amount five times or more the amount of alumina (on a weight basis), the fluxing agent cannot be washed off.

<Analysis of Crystal Structure>

The crystal structure of the alumina particles was analyzed by X-ray diffraction (XRD).

Specifically, Rint-TT II (manufactured by Rigaku Corporation), a wide-angle X-ray diffractometer, was used to perform the analysis. In this process, for the method of measurement, the 2θ/θ method was used. The measurement conditions were Cu/Kα ray, 40 kV/40 mA, a scan speed of 2.0 degrees/minute, a scan range of 5 to 70 degrees, and a step of 0.02 degree.

Consequently, the alumina particles of the examples and the comparative examples showed sharp scattering peaks originating from α-alumina, and no alumina crystal system peaks other than those of an α crystal structure were observed.

From the ratio of the strongest peak heights between α-alumina and transition alumina [α crystallization rate (%)=the strongest peak height of α-alumina/(the strongest peak height of α−alumina+the strongest peak height of transition alumina)×100], the α crystallization rate of the alumina particles was determined to be 95% or more for all of them.

<Shape Analysis>

For the produced alumina particles, observation of a polyhedral shape and measurement of an average particle diameter were performed with a scanning electron microscope (SEM).

Specifically, VE-9800 (manufactured by Keyence Corporation), a surface observation apparatus, was used to perform observation of the polyhedral shape and measurement of the average particle diameter.

More specifically, for the polyhedral shape, an image obtained by a plurality of SEM images from given fields of view of a sample was observed. The shape of 60% or more particles on a number basis was determined to be the polyhedral shape of the sample.

The value of the average particle diameter was an arithmetic mean measured and calculated from 50 alumina particles randomly selected from an image obtained by a plurality of SEM images from given fields of view of a sample.

Consequently, it was confirmed that the alumina particles of the examples and the comparative examples were polyhedral particles with a crystal face other than the [001] face as the main crystal face and having a crystal face with a larger area than that of the [001] face. The alumina particles were other than hexagonal bipyramidal and were polyhedral, which was octahedral or more, particles.

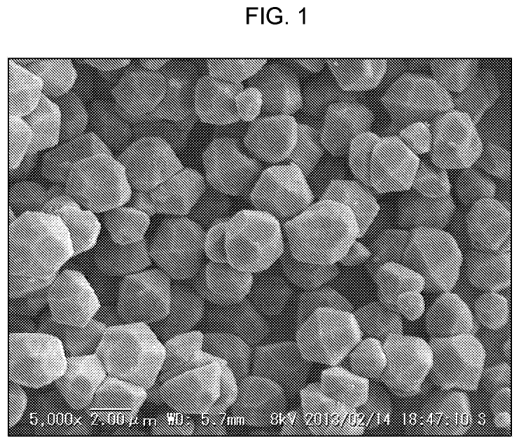

FIG. 1 illustrates a SEM image of the obtained alumina particles of Example 5.

Table 1 lists the values of the average particle diameter of the alumina particles of the examples and the comparative examples.

<Measurement of Molybdenum Content>

The molybdenum content of the produced alumina particles was measured by X-ray fluorescence (XRF).

Specifically, ZSX100e (manufactured by Rigaku Corporation), an X-ray fluorescence analyzer, was used to perform the measurement. In this process, the function point (FP) method was used as the method of measurement. The measurement conditions were using EZ scan, a measurement range of B to U, a measurement diameter of 10 mm, and a sample weight of 50 mg. The measurement was performed with powder as it is, in which a polypropylene (PP) film was used to prevent scattering.

Table 1 lists the ratio of the molybdenum content to 100% by mass of the alumina particles of the examples and the comparative example (in terms of molybdenum trioxide) obtained by the XRF analysis.

TABLE 1

| | | | | | | | Evaluation | | | |
|---|---|---|---|---|---|---|---|---|---|---|
| | | | | | | | MoO₃ | | | |
| | Raw materials | | | | | | sublimation | | Average | |
| | Al type (g) | | | | | | (mass | Taking out | particle | MoO₃ |
| | | Transition | MoO₃ | K₂CO₃ | | | reduction | of alumina | diameter | (% by |
| | Al(OH)₃ | Al₂O₃ | (g) | (g) | [Mo]/[K] | [Mo]/[Al] | after firing) | particles | (μm) | mass) |
| Example 1 | 40 | — | 10 | 10 | 0.47 | 0.135 | Absent | A | 4 | 0.5 |
| Example 2 | 40 | — | 10 | 8 | 0.59 | 0.135 | Absent | A | 4 | 0.6 |
| Example 3 | 40 | — | 10 | 5 | 0.96 | 0.135 | Absent | A | 5 | 0.63 |
| Example 4 | 40 | — | 10 | 2 | 2.3 | 0.135 | Absent | A | 10 | 0.7 |
| Example 5 | 40 | — | 10 | 1 | 4.7 | 0.135 | Small amount | A | 3 | 0.8 |
| Example 6 | 40 | — | 2 | 0.2 | 4.7 | 0.027 | Extremely | A | 3 | 0.4 |
| | | | | | | | small amount | | | |
| Comparative | 40 | — | 10 | — | — | 0.135 | Present (90% | B | 5 | 1.2 |
| Example 1 | | | | | | | by mass) | | | |
| Comparative | — | 26 | 27 | 5 | 0.95 | 0.360 | Absent | C | 50 | 0.9 |
| Example 2 | | | | | | | | | | |

It can be seen that in Examples 1 to 6, in which aluminum hydroxide was used as the raw material, the value of the average particle diameter of the obtained alumina particles was made smaller than that of Comparative Example 2, in which transition alumina was used as the raw material. In the obtained fired product, many small alumina particles were distributed so as to break the continuous phase of the fluxing agent, and the alumina particles were easily taken out of the fluxing agent of this fired product.

In the raw materials of Examples 1 to 6, the [Mo]/[Al] molar ratio was 0.2 or less, and the amount of the fluxing agent with respect to the aluminum raw material was less than that of Comparative Example 2, and the alumina particles were easily taken out of the fluxing agent of the obtained fired product.

In Examples 1 to 6, in which the potassium compound was used as the raw material, the sublimation of MoO₃ was inhibited compared to Comparative Example 1, in which no potassium compound was used as the raw material, and equipment loads for MoO₃ recovery and the like were reduced.

Among them, the sublimation of MoO₃ was particularly inhibited in Examples 1 to 4, in which the [Mo]/[K] molar ratio was 3 or less.

Each configuration and a combination thereof in each embodiment are by way of example, and additions, omissions, substitutions, and other changes of the configuration can be made without departing from the gist of the present invention. The present invention is not limited by the embodiments but limited only by the scope of the claims.

1-6. (canceled)

7. An alumina particle production method comprising a step of firing an aluminum compound in presence of a molybdenum compound and a potassium compound, the aluminum compound containing aluminum hydroxide, and an average particle diameter of the alumina particles is 20 μm or less.

8. The production method according to claim 7, wherein a molar ratio (molybdenum/aluminum) of molybdenum atoms in the molybdenum compound to aluminum atoms in the aluminum compound is 0.01 to 0.2.

9. The production method according to claim 7, wherein a molar ratio (molybdenum/potassium) of molybdenum atoms in the molybdenum compound to potassium atoms in the potassium compound is 0.1 to 5.

10. The production method according to claim 7, wherein the alumina particles contain molybdenum.

11. The production method according to claim 7, wherein the alumina particles are other than hexagonal bipyramidal and are polyhedral particles, with a crystal face other than a [001] face as a main crystal face, and with an area of a largest flat face being one-eighth or less of a total surface area of the aluminum oxide particles.

12. The production method according to claim 8, wherein a molar ratio (molybdenum/potassium) of molybdenum atoms in the molybdenum compound to potassium atoms in the potassium compound is 0.1 to 5.

13. The production method according to claim 8, wherein the alumina particles contain molybdenum.

14. The production method according to claim 9, wherein the alumina particles contain molybdenum.

15. The production method according to claim 8, wherein the alumina particles are other than hexagonal bipyramidal and are polyhedral particles, with a crystal face other than a [001] face as a main crystal face, and with an area of a largest flat face being one-eighth or less of a total surface area of the aluminum oxide particles.

16. The production method according to claim 9, wherein the alumina particles are other than hexagonal bipyramidal and are polyhedral particles, with a crystal face other than a [001] face as a main crystal face, and with an area of a largest flat face being one-eighth or less of a total surface area of the aluminum oxide particles.

17. The production method according to claim 10, wherein the alumina particles are other than hexagonal bipyramidal and are polyhedral particles, with a crystal face other than a [001] face as a main crystal face, and with an area of a largest flat face being one-eighth or less of a total surface area of the aluminum oxide particles.
